(19) United States
(12) Patent Application Publication
(10) Pub. No.: US 2012/0259028 A1
(43) Pub. Date: Oct. 11, 2012

(54) REACTIVE POLYMERIC MIXTURE

(76) Inventors: Peter Plimmer, Auckland (NZ); Christopher Tanner, Auckland (NZ)

(21) Appl. No.: 13/500,814

(22) PCT Filed: Oct. 7, 2010
(86) PCT No.: PCT/NZ2010/000198

§ 371 Date: Jun. 27, 2012

(30) Foreign Application Priority Data
Oct. 7, 2009 (NZ) 580231

(51) Int. Cl. C08L 67/00

(52) U.S. Cl. 521/134

(57) ABSTRACT

The present invention relates to a reactive mixture, comprising poly(hydroxyalkanoic acid) or copolymer thereof and a reactive composition adapted such that a relatively rubbery phase is formed once reacted. Preferably the reactive composition is polymeric and comprises at least first and second reactable components which preferably contain epoxide moieties and carboxylic moieties respectively. The present invention also relates to a method for providing a reactive mixture, the method comprising the steps of combining poly(hydroxyalkanoic acid) or copolymer thereof, a first polymer having epoxide moieties and a second polymer having carboxylic moieties.

The invention also relates to a method for controlling the melt viscosity of a polymeric mass during melt processing.

### FIELD OF THE INVENTION

The present invention relates to polymeric blends, and in particular to a reactive polymeric mixture comprising poly(hydroxyalkanoic acid). The invention has been developed primarily for use in blown film/article manufacture and in foamed applications, and will be described hereinafter with reference to this application. However, it will be appreciated that the invention is not limited to this particular field of use.

### BACKGROUND OF THE INVENTION

The following discussion of the prior art is provided to place the invention in an appropriate technical context and enable the advantages of it to be more fully understood. It should be appreciated, however, that any discussion of the prior art throughout the specification should not be considered as an express or implied admission that such prior art is widely known or forms part of common general knowledge in the field.

Polylactic acid (PLA) can be manufactured from naturally occurring, renewable resources and, unlike petroleum-based polymers, is biodegradable. This polymer offers the packaging industry an environmentally friendly alternative to hydrocarbon polymers such as polyethylene, polystyrene and polyethylene terephthalate. However it has a number of fundamental problems, including: brittleness, permanent set behaviour, dimensional stability of moulded articles and difficulty in melt processing, especially into ‘blown film’.

Also, the complex morphology of PLA naturally creates a structure which has a variable ‘cold crystallization’ rate, which causes moulded articles to exhibit dimensional instability on storage, and also is too brittle for use in food packaging applications, especially when flex durability is a requirement of the packaging material. This peculiar morphological phenomenon also means that PLA is difficult to blow into thin film in the conventional blown film manufacturing process, primarily due to its brittleness and a tendency to form permanent creases as the blown film is collapsed and folded over the take-off nip rolls at the top of the blowing tower.

The blown-film process requires that the molten polymer has high melt strength. The molten, annular-shaped extrudate must be strong enough to respond to the air pressure (which is blown into the inner core of the vertically extruded annulus) by expanding the tube to form a bubble which is 2 to 4 times its diameter at the annular die. This expansion is called the ‘blow-up ratio’, and must occur in a uniform manner to produce a pre-determined wall thickness of typically about 20 to 60 microns. PLA does not respond to this process well, since its melt is not strong enough to be ‘drawn’, and it provides an unstable bubble even at less than a 1.5 blow-up ratio.

The prior art describes attempts at decreasing film brittleness by the addition of low glass transition temperature (Tg) plasticizers to the PLA. This provides a blend with a Tg below that of PLA (48 to 57° C.), which has improved ductility at room temperature. Unfortunately, the improved ductility is accompanied by loss in tensile strength at break, and low molecular weight plasticizers were observed to migrate to the surface of moulded parts (see Jacobsen, S; Fritz, H. G “Plasticizing Polylactide—the effect of different plasticizers on the mechanical properties”, Polym. Eng. Sci. 1999, 39, 1303-1310). This creates a sticky or tacky surface to which print cannot be applied.

High molecular weight plasticizers, such as poly(butylene adipate-co-terephthalate), which would be expected to be less prone to migration, were found to be immiscible with PLA (see Yang, J. M et. al. Polym J. 1997, 29, 657), creating a phase separated blend with variable mechanical properties. In related art, U.S. Pat. Nos. 7,381,772, and 7,354,973 describe ‘toughened’ poly (lactic acid) resin compositions, wherein the PLA is toughened by the blending with a random ethylene copolymer comprising glycidyl groups. Without wishing to be bound by theory, it is believed that the poly(butylene adipate-co-terephthalate), being a polyester, reacts with the Glycidyl Methyl Acrylate (GMA) thereby making it miscible .

Other prior art describes attempts at improving melt strength (referred to as ‘viscosity enhancement’) by the use of chain extension (see Tweed E. C. et.al. “Poly [lactic acid] blown film and method of making same” US Patent Application No. 2006/0045940, and Sodergard A. et.al. (U.S. Pat. No. 6,559,244), “Processable poly[hydroxy acids]”. In this art peroxide crosslinking techniques were employed to enhance the melt strength of PLA in the blown film process, for example see U.S. Pat. No. 6,559,244. However, neither technology provides a high blow-up ratio of PLA.

What is needed is a polymer blend which is capable of producing film at a high blow-up ratio (4:1) using the conventional blown film manufacturing operation, wherein the blown film displays significant puncture and tear resistance relative to unmodified PLA. Further, what is needed is a polymer blend which is capable of producing blown thin gauge film (10-100 micron) with a stable melt bubble and which displays minimal or no creasing on the take-off roll. Further, what is needed is a polymer blend which is capable of producing blown articles, such as bottles, and foamed articles, such as meat trays and the like, which can be processed on conventional manufacturing equipment, wherein the polymer blend displays significant improvement in melt strength compared to, say, unmodified PLA.

It is an object of the present invention to overcome or ameliorate at least one of the disadvantages of the abovementioned prior art, or to provide a useful alternative.

### SUMMARY OF THE INVENTION

According to a first aspect the present invention provides a reactive mixture, comprising poly(hydroxyalkanoic acid) or copolymer thereof and a reactive composition adapted such that a relatively rubbery phase is formed once reacted. Preferably the reactive composition is polymeric.

Preferably the reactive composition comprises at least first and second reactable components. Preferably the reactive composition reacts during melt processing. Preferably the chemical reaction crosslinks the reactive composition, and in particular crosslinks the first and second reactable components, meaning that chemical bonds are formed between the first and second components. Preferably the reactive composition is adapted to also react with said poly(hydroxyalkanoic acid).

It will be appreciated that the first and second reactable components are reactable with each other and preferably at least one of said first and said second reactable components is reactable with the poly(hydroxyalkanoic acid). It will also be appreciated that the polymeric reactable components form a relatively rubbery phase once reacted, meaning that the Tg of the product of the reaction is lower than the Tg of the homopolymer of the poly(hydroxyalkanoic acid). It is also preferred that the Tg of the rubbery phase is below 0° C., and more preferably below -30° C. It will further be appreciated that the relatively rubbery phase is produced in situ, meaning that the reactable components are combined together to form a reactive mixture or reactive blend, and the relatively rubbery phase is produced during reaction of the first and second reactable components and the poly(hydroxyalkanoic acid). The resultant reacted mixture is considered to be an alloy of each of the individual polymeric components, or an interpenetrating-type network of crystalline and rubbery phases.

According to a second aspect the present invention provides a reactive mixture comprising poly(hydroxyalkanoic acid) or copolymer thereof, a first polymer having epoxide moieties and a second polymer having carboxylic moieties.

Poly(hydroxyalkanoic acid) polymers (PHA's) (polyhydroxyalkanoates) are biodegradable polymers. A number of these are also available from processing renewable resources, such as production by bacterial fermentation processes or isolated from plant matter that include corn, sweet potatoes, and the like. Poly(hydroxyalkanoic acid) polymers include polymers prepared from polymerization of hydroxyalkanoic acids having from 2 to 7 (or more) carbon atoms, including the polymer comprising 6-hydroxyhexanoic acid, also known as polycaprolactone (PCL), and polymers comprising 3-hydroxyhexanoic acid, 4-hydroxyhexanoic acid and 3-hydroxyheptanoic acid. Of note are poly(hydroxyalkanoic acid) comprising hydroxyalkanoic acids having five or fewer carbon atoms, for example, polymers comprising glycolic acid, lactic acid, 3-hydroxypropionate, 2-hydroxy- butyrate, 3-hydroxybutyrate, 4-hydroxybutyrate, 3-hydroxyvalerate, 4-hydroxyvalerate and 5-hydroxyvalerate. Notable polymers include poly(glycolic acid) (PGA), poly(lactic acid) (PLA) and poly(hydroxybutyrate) (PHB). PHA compositions also include blends of two or more PHA polymers, such as a blend of PHB and PCL.

Preferably the poly(hydroxyalkanoic acid) is poly(lactic acid).

Polyhydroxyalkanoic acids can be produced by bulk polymerization. For example a poly(hydroxyalkanoic acid) may be synthesized through the dehydration-polycondensation of the hydroxyalkanoic acid. A PHA may also be synthesized through the dealcoholization-polycondensation of an alkyl ester of polyglycolic acid or by ring-opening polymerization of a cyclic derivative such as the corresponding lactone or cyclic dimeric ester. The bulk polymerization is usually carried out by two production processes, i.e., a continuous process and a batch process. PHA polymers also include copolymers comprising more than one PHA, such as polyhydroxybutyrate-hydroxyvalerate (PHB/V) copolymers and copolymers of glycolic acid and lactic acid

(PGA/LA). Copolymers can be prepared by catalyzed copolymerization of a polyhydroxyalkanoic acid or derivative with one or more cyclic esters and/or dimeric cyclic esters. Such comonomers include glycolide (1,4-dioxane-2,5-dione), the dimeric cyclic ester of glycolic acid; lactide (3,6-dimethyl-1 ,4-dioxane-2,5-dione); α,α-dimethyl-β-propiolactone, the cyclic ester of 2,2-dimethyl-3-hydroxy- propanoic acid; β-butyrolactone, the cyclic ester of 3-hydroxybutyric acid, δ-valerolactone, the cyclic ester of 5-hydroxypentanoic acid; ε-capro- lactone, the cyclic ester of 6-hydroxyhexanoic acid, and the lactone of its methyl substituted derivatives, such as 2-methyl-6-hydroxyhexanoic acid, 3-methyl-6-hydroxyhexanoic acid, 4-methyl-6-hydroxyhexanoic acid, 3,3,5-trimethyl-6-hydroxyhexanoic acid, etc., the cyclic ester of 12-hydroxy-dodecanoic acid, and 2-p-dioxanone, and the cyclic ester of 2-(2-hydroxyethyl)-glycolic acid.

PHA compositions also include copolymers of one or more PHA monomers or derivatives with other comonomers. The skilled person will understand which copolymers may be utilised for the present invention. PHA polymers and copolymers may also be made by living organisms or isolated from plant matter. Numerous microorganisms have the ability to accumulate intracellular reserves of PHA polymers. For example, the copolymer poly(3-hydroxybutyrate-co-3-hydroxyvalerate) (PHB/V) has been produced by fermentation of the bacterium Ralstonia eutropha. Fermentation and recovery processes for other PHA types have also been developed using a range of bacteria including Azotobacter, Alcaligenes latus, Comamonas testosterone and genetically engineered E. coli and Klebsiella.

When used herein, the term “poly(hydroxyalkanoic acid)” refers to a polymer or composition comprising any homopolymer or copolymer comprising a hydroxyalkanoic acid and mixtures thereof, such as those homopolymers, copolymers and blends listed above. Likewise, when a specific hydroxyalkanoic acid is used in such a term, such as poly(glycolic acid), poly(lactic acid) (PLA) or poly(hydroxybutyrate), the term includes homopolymers, copolymers or blends comprising the hydroxyalkanoic acid used in the term.

Poly(lactic acid) (PLA) includes poly(lactic acid) homopolymers and copolymers of lactic acid and other monomers containing at least 50 mole % of repeat units derived from lactic acid or its derivatives and mixtures thereof having a number average molecular weight of 3,000 to 1 ,000,000, 10,000 to 700,000, or 20,000 to 600,000. The poly(lactic acid) may contain at least 70 mole % of repeat units derived from (e.g. made by) lactic acid or its derivatives. The poly(lactic acid) homopolymers and optical copolymers can be derived from d-lactic acid, 1-lactic acid, or a mixture thereof or d-lactide, 1-lactide, meso-lactide or a mixture thereof. The poly(lactic acid) molecular structure can be random optical copolymers, isotactic optical homopolymers, block optical copolymers, and so on. A mixture of two or more poly(lactic acid) polymers can be used. A mixture can be a melt blend of isotactic optical poly(lactic acid) homopolymer which gives a higher melt point component in the blend of optical homopolymers which is a stereo-complex poly(lactic acid). The blend can be an equal part of the two isotactic optical homopolymers which gives a higher melt point stereo complex poly(lactic acid). Poly(lactic acid) may be prepared by the catalyzed ring-opening polymerization of the dimeric cyclic ester of lactic acid, which is referred to as “lactide.” As a result, poly(lactic acid) is also referred to as “polylactide.”

Copolymers of lactic acid are typically prepared by catalyzed copolymerization of lactic acid, lactide or another lactic acid derivative with one or more cyclic esters and/or dimeric cyclic esters as described above.

Preferably the first polymer additionally comprises epoxide for example glycidyl methacrylate, isocyanate, axiridine, silane, alkyl halide, alpha-halo ketone, alpha-halo aldehyde, and/or oxazoline moieties or mixtures thereof. The skilled person will appreciate which other moieties could be selected in order to react with the second polymer having the carboxylic moieties.

The polymers bearing epoxy or glycidyl groups and the organic acid groups may be any polymers. However, preferred polymers are those based on ethylene and/or propylene, and may include grafted homo polymers or copolymers. In one preferred embodiment, the ethylene or propylene copolymer bearing glycidyl groups is made by polymerizing monomers (a) ethylene and/or propylene and (b) one or more olefins of the formula CH₂═C(R¹)CO₂R², where R¹ is hydrogen or an alkyl group with 1 to 8 carbon atoms such as methyl, ethyl, or butyl, and R² is a glycidyl/epoxy moiety. An example of an ethylene copolymer is derived from ethylene, butyl acrylate, and glycidyl methacrylate and referred to as EBAGMA. Repeat units derived from monomer (a) may comprise about 20 to about 95 weight %, about 20 to about 90 weight %, about 40 to about 90 weight %, or about 50 to 80 weight % of the of the total weight of the ethylene copolymer. Repeat units derived from monomer (b) may comprise about 3 to about 70 weight %, about 3 to about 40 weight %, about 15 to about 35 weight %, or about 20 to about 35 weight % of the total weight of the ethylene copolymer. The ethylene copolymer may additionally be derived from carbon monoxide (CO) monomers. When present, repeat units derived from carbon monoxide may comprise up to about 20 weight % or about 3 to about 15 weight % of the total weight of the ethylene copolymer. The ethylene copolymers used in the composition preferably are random copolymers that can be prepared by direct polymerization of the foregoing monomers in the presence of a free-radical polymerization initiator at elevated temperatures, about 100 to about 270° C., and at elevated pressures, at least about 70 MPa or about 140 to about 350 MPa. The ethylene copolymers may also be prepared using a tubular process, an autoclave, or a combination thereof, or other suitable processes. The ethylene copolymers may be not fully uniform in repeat unit composition throughout the polymer chain due to imperfect mixing during polymerization or variable monomer concentrations during the course of the polymerization.

Preferably the ethylene copolymer bearing organic carboxylic acid groups is made by polymerizing monomers (a) ethylene (b) one or more olefins of the formula CH₂═C(R¹)COOH, where R¹ is hydrogen or an alkyl group with 1 to 8 carbon atoms such as methyl, ethyl, or butyl. An example of an ethylene copolymer is derived from ethylene and methacrylic acid. Repeat units derived from monomer (a) may comprise about 20 to about 95 weight %, about 20 to about 90 weight %, about 40 to about 90 weight %, or about 50 to 80 weight % of the of the total weight of the ethylene copolymer. Repeat units derived from monomer (b) may comprise about 3 to about 70 weight %, about 3 to about 40 weight %, about 15 to about 35 weight %, or about 20 to about 35 weight % of the total weight of the ethylene copolymer. The ethylene copolymer may additionally be derived from carbon monoxide (CO) monomers. When present, repeat units derived from carbon monoxide may comprise up to about 20 weight % or about 3 to about 15 weight % of the total weight of the ethylene copolymer. The ethylene copolymers used in the composition preferably are random copolymers that can be prepared by direct polymerization of the foregoing monomers in the presence of a free-radical polymerization initiator at elevated temperatures, about 100 to about 270° C., and at elevated pressures, at least about 70 MPa or about 140 to about 350 MPa. The ethylene copolymers may also be prepared using a tubular process, an autoclave, or a combination thereof, or other suitable processes. The ethylene copolymers may be not fully uniform in repeat unit composition throughout the polymer chain due to imperfect mixing during polymerization or variable monomer concentrations during the course of the polymerization.

Preferably the epoxide moieties are derived from glycidyl acrylate or methacrylate, and the carboxylic moieties are derived from acrylic or methacrylic acid.

Preferably the compositions of the invention comprise between about 60 to about 95 weight percent poly(lactic acid) and between about 5 to about 40 weight percent of a mixture of high molecular weight random ethylene copolymers which are capable of chemically reacting to form an in-situ rubbery phase having a glass transition temperature (Tg) below room temperature. Preferably the in-situ rubbery phase is also permanently attached to the semicrystalline PLA, thus forming an alloy which is comprised of two phases—one hard, one soft. Without wishing to be bound by theory, the soft rubbery phase is thought to form a ‘bridge’ connecting adjacent hard PLA phases, thereby acting as a ‘crosslink’ without detracting from the melt processability of the alloy. Without wishing to be bound by theory, it is contemplated that the rubbery phase itself is not crosslinked in the conventional sense, although the PLA phase could be considered to act as a crosslink between the in-situ rubbery phases.

Preferably the compositions of the invention comprise about 60, 65, 70, 75, 80, 85, 90 or 95 weight percent poly(lactic acid), with the remainder being the high molecular weight random ethylene copolymers.

Preferably the mixture of ethylene copolymers comprises about 5 to 8 weight percent of glycidyl functionality and about 10 weight percent of organic carboxylic acid functionality. Preferably the ethylene copolymers also contain up to 30 weight percent of an additional acrylate or methacrylate monomer having a glass transition temperature from about -25 to -60° C.

It will be appreciated that whilst preferred polymers (bearing the epoxide and organic acid functionality) used in the reactive mixture of the invention are ethylene-based, other polymers are possible. For example styrene/acrylic based polymers. Other suitable polymers will be known to those skilled in the art.

Preferably the reactive mixture of the invention comprises at total of about 0.1 to 15 wt % of glycidyl functionality, and total of about 0.1 to 15 wt % of organic carboxylic acid functionality. It will also be appreciated that each of the individual (co)polymers (bearing the epoxide and organic acid functionality) may comprise from 1 to 40% functionality of the epoxide and organic acid groups. The molar ratio of glycidyl-to-organic acid functionality in the reactive mixture (provided by the combination of ethylene copolymers discussed above) can be from about 0.2 to 1.7, or about 0.15 to 2.1. Other ranges comprise 0.05 to 2.5, and 0.1 to 2.5. The ethylene copolymer phase of the alloy comprises is typically from about 5 to 20 percent, based on the PLA content of the alloy.

It is contemplated that the ratio of glycidyl-to-organic acid functionality in the reactive mixture should be equal molar amounts (1:1 molar ratio) to provide a complete reaction. However, an excess is required of glycidyl functionality to react with the PLA, say for example a glycidyl-to-organic acid functionality of (1.63:1) is suitable (see Table 2). However, it will be appreciated that other glycidyl-to-organic acid functionality ratios will be suitable for the present invention, for example ranges between 1.2:1 to 5:1. It has been unexpectedly discovered that glycidyl-to-organic acid molar ratios of (1:0.215) provide improved performance compared to unmodified PLA. For example see formulation 40 in Table 1. Without wishing to be bound by theory, it is contemplated that an additional chemical reaction is occurring, such as a transesterfication between the PLA and the organic acid functional polymer. Alternatively, and again without wishing to be bound by theory, the organic acid functional polymer may be providing additional melt strength.

The present invention provides novel compositions of poly(hydroxy alkanoic acid), and in particular poly(lactic acid), which can be used effectively in blown film. Pure PLA or known composites do not have a strong enough “melt” to be drawn and blown, and/or any formed film has very poor tear characteristics. These surprising improvements in melt strength mean that the present invention provides modified poly(hydroxy alkanoic acid) materials which can be used for foamed products and blown articles, such as bottles and the like. The skilled person will readily appreciate which other types of articles will benefit from having improved or controlled melt strength by using the reactive mixture of the present invention. For example, the novel reactive mixtures of the invention have also been used to produce blow moulded articles such as bottles. Whilst PLA bottles are known, they are sensitive to distortion at elevated temperatures. In contrast PLA bottles produced using the present invention are unaffected by heat treatment at 80° C. for 60 min, which are conditions which cause severe distortion of conventional PLA bottles and therefore limits the use of PLA bottles in the bottling or processing of liquids or solutions which require heat treatment or heat for ease of processing. The novel mixtures of the invention can also be also be produced in an opaque form or a transparent form, which is achieved by manipulation of the various components of the reactive mixture.

The novel reactive mixtures of the invention have also been used to produce extruded foamed sheets. These are important products for various markets, such meat packaging trays.

In one preferred embodiment, the present invention describes the modification of PLA to allow it to be processed as easily as low, or linear low density polyethylene into thin gauge film using the conventional blown film manufacturing process, at high blow-up ratios without the film taking on a permanent set whilst folding over the take-off roll. Additionally, this film exhibits superior puncture and tear- resistance relative to film made from natural PLA. The alloy of the invention exhibits an unexpectedly melt strength improvement relative to pure PLA. This high melt strength provides excellent bubble stability, and the conversion of the alloy into thin film using a conventional blown film manufacturing operation, with easy gauge control and without folded film creasing.

In a related embodiment, the novel reactive mixtures of the invention can be further modified with an additional component for further improving the tear strength of blown film. The additional component is preferably a polymer which is relatively more elastic than the reacted mixture of the invention. The skilled person will appreciate that such polymers will comprise a Tg lower than that of the Tg of the reacted mixture of the invention. In particular, preferably the low Tg polymers participate in the reaction of the novel compositions/alloys of the invention, and are preferably chosen to improve the rate of biodegradation of the alloy. For example, suitable polymers are PBAT or PBS (or a soft low Tg ethylene Ter polymer) since they participate in the reaction and they also can react with the PLA through transesterification. Preferably the polymers are high molecular weight and are biodegradable. The addition of such high molecular weight biodegradable polymeric polyester, which is permanently grafted to the two-phase alloy/matrix of the invention, provides a greatly enhanced tear and puncture resistance. This immiscible polymeric plasticizer, once grafted to the alloy matrix, cannot migrate out of the matrix, which prevents the undesirable property deterioration associated with the ‘cold crystallization’ phenomenon characteristic of pure PLA. The plasticizer should preferably have a low glass transition temperature be effective, for example below about −30° C. The addition of this component also enhances the biodegradation rate of the entire system by (a) minimizing the level of non-biodegradable, ethylene copolymer , content of the alloy(b) attracting water to the film which accelerates the initial hydrolysis step of the degradation process. This allows some variants of the alloy to be commercially composted (as defined by the recognized International Composting Standard EN 13432).

It will be appreciated that the present invention enables the production of decomposable/compostable films which are suitable for a range of applications. For example, decomposable horticultural bags.

The reactive mixtures of the invention may also optionally further comprise other additives such as about 0.5 to about 50 weight % plasticizer; about 0.1 to about 5 weight % antioxidants and stabilizers; about 0.1% to about 1.5% chain extender; about 3 to about 40 weight % fillers; about 5 to about 40 weight % reinforcing agents; about 0.5 to about 10 weight % nanocomposite reinforcing agents; and/or about 1 to about 40 weight flame retardants. Examples of suitable fillers include glass fibers and minerals such as precipitated CaCO₃, talc, and wollastonite.

The reactive mixtures of this invention may optionally further comprise constituents meeting the requirements for food contact applications.

According to a third aspect the present invention provides a method for providing a reactive mixture, said method comprising the steps of combining poly(hydroxyalkanoic acid) or copolymer thereof, a first polymer having epoxide moieties and a second polymer having carboxylic moieties.

According to a fourth aspect the present invention provides a method for controlling the melt viscosity of a polymeric mass, said method comprising the steps of: combining a sufficient quantity of a reactive mixture with said polymeric mass such that during melt processing of said polymeric mass said melt viscosity is increased, wherein said reactive mixture comprises a poly(hydroxyalkanoic acid) or copolymer thereof, a first polymer having epoxide moieties and a second polymer having carboxylic moieties.

In one preferred embodiment, the poly(hydroxyalkanoic acid), the polymer having glycidyl groups and the polymer having organic acid groups are mixed simultaneously and then exposed to reactive compounding conditions. In an alternative embodiment, the poly(hydroxyalkanoic acid) and the polymer having glycidyl groups are premixed and then added to the polymer having organic acid groups. In yet a further embodiment, the poly(hydroxyalkanoic acid) and the polymer having organic acid groups are premixed and then added to the polymer having glycidyl groups. The skilled person will appreciate that a portion of the glycidyl groups react with the organic acid, and a portion reacts with the PLA. It is undesirable for the ethylene copolymers to be premixed, since they will react and form copolymer rich phases which won't properly disperse or react with the PLA. Therefore, the reaction between the ethylene copolymer having glycidyl groups and the ethylene copolymer having organic acid groups should preferably take place in the presence of the competing epoxide/PLA reaction. Preferably the three components are mixed together, however, as discussed above the PLA and the ethylene copolymer having organic acid groups could be mixed, then the ethylene copolymer having glycidyl groups could be added to that, or vice versa.

The skilled person will appreciate that once mixed, the reactive mixture can be processed into a product by exposing the reactive mixture to suitable conditions to react the first and second polymers and the poly(hydroxyalkanoic acid). For example the reactive mixture of the invention can be reacted melt blending the PHA and ethylene copolymers until they are homogeneously dispersed to the naked eye and do not delaminate upon injection molding. Other materials (e.g. ethylene-acrylate copolymers, ionomers, grafting agents, and other additives) may be also uniformly dispersed in the PHA-ethylene copolymer matrix. The blend may be obtained by combining the component materials using any melt-mixing method known in the art. For example: 1) the component materials may be mixed to homogeneity using a melt-mixer such as a single or twin-screw extruder, blender, kneader, Banbury mixer, roll mixer, etc., to give a resin composition; or 2) a portion of the component materials can be mixed in a melt-mixer, and the rest of the component materials subsequently added and further melt-mixed until homogeneous.

The present invention contemplates an article comprising or produced from the polymeric reactive mixture of the invention disclosed herein. The reactive mixture may be molded into articles using any suitable melt-processing technique. Commonly used melt-molding methods known in the art such as injection molding, extrusion molding, or blow molding. The reactive mixture may be formed into films and sheets by extrusion to prepare both cast and blown films. The sheets maybe foamed during extrusion, by gas direct injection or by the addition of a chemical foaming agent. These sheets may be further thermoformed into articles and structures that may be oriented from the melt or at a later stage in the processing of the reactive mixture. The reactive mixture may also be used to form fibers and filaments that may be oriented from the melt or at a later stage in the processing of the reactive mixture. Examples of articles that may be formed from the compositions include, but are not limited to, knobs, buttons, disposable eating utensils, films, thermoformable sheeting and the like. Parisons used in blow molding containers may be prepared by injection molding or extrusion blow molding. Blow molded containers include bottles, jars and the like. Films and sheets can be used to prepare packaging materials and containers such as pouches, lidding, thermoformed containers such as trays, cups, and bowls.

Film

A film may comprise the polymeric reactive mixture of the invention. The film may be monolayer or a multilayer comprising at least any of the following numbers of layers: 2, 3, 4, 5, 7, or 9. The term “layer” in conjunction with a film refers to a discrete film component which is substantially coextensive with the film and has a substantially uniform composition. Where two or more directly adjacent layers have essentially the same composition, then these two or more adjacent layers may be considered a single layer for the purposes of this application.

### Definitions

In describing and claiming the present invention, the following terminology will be used in accordance with the definitions set out below. It is also to be understood that the terminology used herein is for the purpose of describing particular embodiments of the invention only and is not intended to be limiting. Unless defined otherwise, all technical and scientific terms used herein have the same meaning as commonly understood by one having ordinary skill in the art to which the invention pertains.

Unless the context clearly requires otherwise, throughout the description and the claims, the words ‘comprise’, ‘comprising’, and the like are to be construed in an inclusive sense as opposed to an exclusive or exhaustive sense; that is to say, in the sense of ‘including, but not limited to’.

Other than in the operating examples, or where otherwise indicated, all numbers expressing quantities of ingredients or reaction conditions used herein are to be understood as modified in all instances by the term ‘about’. The examples are not intended to limit the scope of the invention. In what follows, or where otherwise indicated, ‘%’ will mean ‘weight %’, ‘ratio’ will mean ‘weight ratio’ and ‘parts’ will mean ‘weight parts’.

To provide a more concise description, some of the quantitative expressions given herein are not qualified with the term ‘about’. It is understood that whether the term ‘about’ is used explicitly or not, every quantity given herein is meant to refer to the actual given value, and it is also meant to refer to the approximation to such given value that would reasonably be inferred based on the ordinary skill in the art, including approximations due to the experimental and/or measurement conditions for such given value.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The terms ‘predominantly’ and ‘substantially’ as used herein shall mean comprising more than 50% by weight, unless otherwise indicated.

The recitation of a numerical range using endpoints includes all numbers subsumed within that range (e.g., 1 to 5 includes 1, 1.5, 2, 2.75, 3, 3.80, 4, 5, etc.).

The terms ‘preferred’ and ‘preferably’ refer to embodiments of the invention that may afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

Headings of sections provided in this patent application and the title of this patent application are for convenience only, and are not to be taken as limiting the disclosure in any way.

PBAT=poly(butylene adipate-co-terephthalate), e.g. EnPOL 8060 from IRe Chem.

PBS=poly(butylene succinate), e.g. EnPOL 4560 from IRe Chem.

PLA=Polylactic acid, e.g. PLA4042 from Natureworks.

GMA=glycidyl methacrylate polymer, e.g. Elvaloy PTW from DuPont , Biomax Strong 120 from DuPont or Lotader AX8900 from Arkema.

A=acid copolymer, e.g. Surlyn 9320 from DuPont

In the attached tables ECOPOL=abbreviation of Ethylene Copolymer

As described herein, when referring to ‘Bubble Stability“, the following descriptions apply:
Poor—Extremely difficult to form and control a blown film bubble; bubble may tear or cannot be easily controlled, and possibly bulges or snakes up the tower .
Good—Produces good film at little or no blow up but bubble control deteriorates as the blow up ratio is increased.
Very Good—Produces an acceptable film under all normal process parameters.

“Copolymer” means polymers containing two or more different monomers. The terms “dipolymer” and “terpolymer” mean polymers containing only two and three different monomers respectively. The phrase “copolymer of various monomers” means a copolymer whose units are derived from the various monomers.

As used herein, the term “ethylene copolymer” refers to a polymer derived from (e.g. made from) ethylene and at least one or two additional monomers.

Compostable polymers are those that are degradable under commercial composting conditions (EN 13432). They break down under the action of organisms (annelids) and microorganisms (bacteria, fungi, algae), achieve total mineralization (conversion into carbon dioxide, methane, water, inorganic compounds or biomass under aerobic conditions) at a high rate and are compatible with the composting process.

Biodegradable polymers are those that are capable of undergoing decomposition into carbon dioxide, methane, water, inorganic compounds or biomass in which the predominant mechanism is the enzymatic action of microorganisms that can be measured by standardized tests, in a specified time, reflecting available disposal conditions.

Renewable polymers are those that comprise or are prepared from raw or starting materials that are or can be replenished sooner than within a few years (unlike petroleum which requires thousands or millions of years), such as by fermentation and other processes that convert biological materials into feedstock or into the final renewable polymer.

### Preferred Embodiment of the Invention

Numerous embodiments are described in this patent application, and are presented for illustrative purposes only. The described embodiments are not intended to be limiting in any sense. The invention is widely applicable to numerous embodiments, as is readily apparent from the disclosure herein. These embodiments are described in sufficient detail to enable those skilled in the art to practice the invention, and it is to be understood that other embodiments may be utilized and that other changes may be made without departing from the scope of the present invention. Accordingly, those skilled in the art will recognize that the present invention may be practiced with various modifications and alterations. The present disclosure is thus neither a literal description of all embodiments of the invention nor a listing of features of the invention that must be present in all embodiments.

The present invention is a high melt strength thermoplastic composition comprising poly (lactic acid) and an in-situ formed, low Tg, rubbery phase which is based on a mixture of ethylene copolymers. This melt strength, at PLA processing temperature (200-230° C.), provides a dimensionally stable bubble in the blown film operation. The bubble can be expanded beyond a 4:1 blow-up ratio, which is similar to the behaviour of low density polyethylene, the industry standard for blown film manufacture.

The present invention applies to either semicrystalline or amorphous PLA, and is independent of the ratios of L-lactides, and D-lactides. The samples of PLA were supplied by Natureworks (PLA 4042D, 4060D, and 3051D) and dried in a desiccant drier as per supplier's recommendations.

The in-situ rubbery phase results from the interaction of an epoxy (glycidyl) group on one ethylene copolymer with an organic acid group on a second ethylene copolymer. The glycidyl-containing ethylene copolymers are available from the DuPont Company (Elvaloy PTW), with about 5 weight percent glycidyl methacrylate (GMA), or Arkema (Lotader AX 8900), containing about 8 weight percent glycidyl methacrylate (GMA). The glycidyl component is present as a randomly copolymerized co-monomer in both cases. The Elvaloy polymer contains about 30 weight percent of n-butyl acrylate as a third monomer in the polymerization, and the Lotader contains about 24 weight percent of methyl acrylate as a third monomer in the polymerization with ethylene.

The organic acid-containing ethylene copolymer is available from the DuPont Company as Surlyn 9320. This ethylene copolymer contains about 10 weight percent of copolymerized methacrylic acid, which has been about 40 percent neutralized with zinc. This ethylene copolymer also contains about 30 weight percent of n-butyl acrylate as a third monomer in the polymerization with ethylene.

The composition of the present invention may also optionally comprise other organic acid containing ethylene copolymers such as Iotek (Ionomer-Exxon Mobil), Aclyn (Ionomer—Honeywell), Nucrel (ethylene/methacrylic acid—DuPont), Primacor (ethylene acrylic acid—Dow), maleic anhydride-grafted polyolefins, maleic anhydride co-polyolefins (Vamac) epoxy-containing polymers and additives (such as BASF Joncryl 4368 ,Clariant Cesa Extend, Hexion Epon, epoxidised soybean oil, epoxidised linseed oil or Sumitomo's E/GMA copolymers) as well as additives, such as plasticizers, chain extenders, lubricants, antioxidants, antiblock, slip additives, colorants and stabilizers, fillers or flame retardants.

The tear/puncture- resistant enhancing additive is preferably a low Tg, high molecular weight polyester, such as poly(butylene adipate-co-terephthalate) Tg=−33° C., or polybutylene succinate Tg=−34° C. Total compatibility with PLA is not required since the PBAT or PBS modifier becomes grafted to the alloy.

The composition of the present invention may optionally comprise other, non grafting, tear /puncture-resistance enhancing additives such as ethylene acrylate copolymer, Elvaloy AC (DuPont), Lotryl (Arkema) Optema (Exxon Mobil) or ethylene vinyl acetate copolymer/terpolymer, Evatane or Orevac (Arkema), Elvax or Elvaloy (DuPont). Use of these additives may reduce compostability somewhat.

The composition is prepared by melt blending the predried PLA and the ethylene copolymers under high shear to create a highly compatibilized alloy in which the in-situ rubbery phase is permanently attached to the PLA. The chemical reaction occurring between the reactive sites on the polymeric components of this initial blend can be measured by carrying out the mixing in a Brabender Model 835201.001 and measuring the increase in mixing energy (drive torque) as a function of time and temperature. The creation of the in-situ rubbery phase and the simultaneous grafting of this rubbery phase to the PLA causes the mobility of the initial blend to decrease as the two-phase alloy forms—resulting in an increase in torque on the drive motor. During this procedure the polymeric plasticiser becomes permanently grafted to one or both of the PLA and the ethylene copolymers.

It is considered undesirable for the ethylene copolymers to prematurely react since this can result in the formation of an ethylene copolymer-rich phase which appears as a gel particle in the final film product.

The dry PLA/in-situ rubbery phase alloy is converted to blown film using a laboratory-scale blown film line operating at 190° C., in order to evaluate the bubble stability, crease performance and a qualitative estimate of mechanical properties. Film samples of quality film for quantitative testing were made using a Yoshi blown film unit producing 20 to 80 micron film from a 45mm extruder operating at 205 to 220° C. The films were also exposed to oven aging (60° C. for 24 hours), to evaluate dimensional stability, aesthetics, and change in crystalline content (DSC).

It is further contemplated that a biaxially oriented film produced with the reactive mixture of the invention may improve crystallinity, which could minimise the “ageing” behaviour of PLA at room temperature which leads to brittleness after about 3 to 8 hours post production. Further advantages relate to improve gas barrier performance and the development of a high Tm crystalline phase. It is yet further contemplated that products produced with the reactive mixture of the invention will display improved thermal and mechanical performance.

### EXAMPLES

The present invention will now be described with reference to the following examples which should be considered in all respects as illustrative and non-restrictive.

Torque data was generated using a Brabender compounding head. The ‘final torque’ (in Nm) reported in the Tables was measured after a 15 minute mixing time at 190° C., and is used as an indirect measurement of melt strength. This data was correlated with the qualitative ‘poor’ and ‘very good’ bubble stability observations from the small laboratory blown film line in the Tables below, and the observations from the small laboratory blown film line were confirmed by the ‘blow-up ratio’ performance observed with selected candidate alloy formulations using a large plant-scale blown film line.

Compounding of quantities of material for large scale blown film production was carried out in a Labtech 26mm LTE 26-40 corotating twin screw extruder with a screw design which created high shear on the polymer melt, with barrels and die set to about 160 to 220° C. and 200 rpm, to generate a melt temperature of about 200 to 225° C., a production rate of about 10 kg per hour, and extruded through a two-hole die. The molten material was discharged into a water trough and cut into strands.

Prior to blowing into film the alloys were dried in a desiccant dryer for 8 hours at 60° C. and converted to blown film using an 45 mmYoshi extruder with a barrel temperature of 205° C., and a die temperature of 220° C.

### COMPARATIVE EXAMPLES

1. Demonstration that the Individual ethylene copolymers do not Provide Melt Strength

Following a 15 minute exposure in a Brabender mixing head set at 190° C., the final torques recorded in Table 1 for control samples B, C and D show that there is a strong chemical interaction between PLA and either the glycidyl or organic acid functionality of the ethylene copolymers (Surlyn 9320, Elvaloy PTW or Lotader 8900). The torque rises from a baseline of 7.7 (for the pure PLA) to a final torque of 14.9 for ‘C’ and to 21.9 for ‘D’. However, the final alloy displays poor bubble stability, as measured on the laboratory-scale blow film line which is not significantly better than PLA alone.

Although increasing the glycidyl concentration in the alloying mixture from 0.549 mole % (C) to 0.844 mol % (D) generates greater final torque, the resultant alloy does not have the desired bubble stability.

2. Demonstration that there is a Synergistic Combination between the Glycidyl- and Organic Acid-Containing ethylene copolymers

Samples 50, 25, 40 (Table 1) contain a combination of glycidyl- and organic acid-containing ethylene copolymers and generated final torque values from 16.8 to 18.6. This torque range includes the torque generated with control D of example 1, but film blown from these compositions have excellent bubble stability relative to the control D. This shows that there is a synergistic effect between the GMA-functionalized and the acid-functionalized ethylene copolymers and the PLA.

3. Demonstration that there is a Molar Ratio Range of Glycidyl-to-Acid (GMA/A) functionality which provides torque rise plus bubble stability (melt strength)

Samples 50, 25, 40 (Table 1) contain a GMA/A molar ratio of between 0.212 to 0.215, with very good bubble stability. Films samples 45, 20, 48 (Table 2) displayed very good bubble stability at GMA/A molar ratios of between 1.08 to 1.63. This indicates that the creation of the high melt strength alloy is dependent on the presence of a minimum level of organic acid functionality. This is demonstrated by sample 67 (Table 2).

4. Demonstration that there is a Minimum Level of ‘in-situ rubber’ Required to Generate Bubble Stability

Samples 64 and 65 (Table 1) show that, even at a low GMA/Acid molar ratio of 0.245, and the development of 16.9 to 17.5 final torque, a minimum level of ‘rubber’ mass (from the in-situ combination of the two ethylene copolymers) measured as the ratio of the sum of the ethylene copolymers to the PLA as a percentage (Ecopol/ PLA),is required to achieve good, or marginally acceptable, blown film bubble stability. A minimal level of the in-situ rubber appears to fall at about 9% (sample 67 of Table 2), Surlyn 2.8 phr plus Lotader 6.2 phr divided by PLA , 100 phr,=9% ‘insitu rubber’.

5. Demonstration that High GMA/Acid Molar Ratios can be used to Create Bubble Stable Blown Film

Samples 45, 20, 48 (Table 2) contain relatively high levels of glycidyl functionality (a high GMA/ Acid molar ratio of 1.08 to 1.63) and generate a final torque in excess of 18.3. These alloys exhibit excellent bubble stability. But even at this high GMA level the bubble stability deteriorates as the in-situ rubber mass (Ecopol/ PLA) falls below about 9% (samples 66, 67).

6. Demonstration that the High Molecular Weight polymeric polyester Plasticizer Interacts (Grafts) with the Epoxy (GMA) Component of the Alloy Matrix

The final torque observed for control sample F (5.3Nm, Table 4) is 47% greater relative to control sample E (3.6Nm, Table 4), and is the result of melt reacting poly(butylene adipate-co-terephthalate, PBAT) with an ethylene copolymer carrying 0.732 mole % of GMA. This is consistent with the chemical interaction (grafting) of the PBAT to the ethylene copolymer. In the absence of the GMA-containing polymer, there is no torque rise (sample E).

7. Demonstration that the Presence of 20 Parts of High Molecular Weight poly(butylene adipate-co-terephthalate), PBAT, does not Interfere with the Final Torque Rise During the Preparation of the Alloy

The final torque data recorded for samples 3, 27, 41, 55, (in Table 3) 28, 46, and 54 (in Table 4) show that there is a strong chemical interaction between PLA, PBAT and either the glycidyl or organic acid functionality of the ethylene copolymers (Surlyn 9320, Elvaloy PTW or Lotader 8900). The torque rises from a baseline of 13.4 (Sample 62, which is the control PLA/PBAT blend) to a final torque of 17.0 for sample 55 and a final torque of 20.5 for sample 46. This means that the PBAT is not acting as a simple plasticiser, which would actually lead to reduced torque.

8. Demonstration that the Presence of 20 Parts of High Molecular Weight poly (butylene adipate-co-terephthate), PBAT, does not Interfere with the Creation of the ‘High Melt Strength’ Composition

Samples 3, 27, 41 and 55 (Table 3), and 28, 46, 54, (Table 4) contain a broad range of combinations of glycidyl- and organic acid-containing ethylene copolymers. In all cases final torque values of between about 17 to 20.5 Nm were generated, and film blown from these compositions have excellent bubble stability.

9. Demonstration that the Presence of PBAT does not Interfere with the Creation of High Melt Strength Compositions over a Range of Molar Ratios of Glycidyl-to-Acid (GMA/Acid) Functionality

Samples 3, 27, 41, and 55 (Table 3) contain GMA/A molar ratios of 0.212 to 0.215, while samples 28, 46, 54 (Table 4) contain GMA/A molar ratios of 1.06 to 1.63. All contain 20 phr of PBAT and have very good bubble stability

10. Demonstration that there is a Minimum Level of ‘in-situ Rubbery Phase’ Required to Generate Bubble Stability in PBAT Containing Compositions.

Samples 58 and 61 (Table 3) show that, even at a GMA/ Acid ratio of 0.245 (and the development of 16.6Nm final torque), a minimum level of ‘rubbery’ mass (from the in-situ combination of the two ethylene copolymers) is required to achieve good, or marginally acceptable, blown film bubble stability. The ‘minimal’ level of the ‘in-situ’ rubbery phase is now about 7.5% (sample 61), based on 9 phr of Surlyn plus Lotader and 120 phr of total polyesters (PLA+PBAT).

A similar scenario is shown for samples 59 and 63 (Table 4), where a GMA/Acid ratio of about 1.08 produces poor bubble stability when the ethylene copolymer component falls to about 7% of the total polyester alloy.

11. Demonstration that Films Containing PBAT have Enhanced Puncture and Tear-Resistance

The tear and puncture resistance of pure PLA is typically low. Table 5 contains mechanical property data generated from films prepared on commercial scale blown film equipment. These 60 micron films were made at high blow-up ratios (4:1) and were free from surface blemishes, and were tested according to ASTM testing protocol.

All samples of the high quality blown film shown in Table 5 exhibited excellent isotropic tear and tensile properties, with puncture resistance and yield strength superior to linear low density polyethylene—the ‘standard’ of the packaging film industry. Tear resistance is isotropic with machine direction (MD) and transverse direction (TD) values of around 10mN/micron, which is below that of LLDPE but well within the needs of the packaging industry.

When comparing samples 40 and 41, it is evident that the addition of 20 phr of PBAT provides a relative 86% increase in puncture resistance and a 43% increase in tear resistance. The GMA/ Acid molar ratios of samples 40 and 41 (Table 5) are 0.215, and these sample differ only in that sample 40 contains zero PBAT. However, their non-biodegradable contents differ since sample 41 contains a higher total level of polyester (PLA+PBAT).

Similarly, comparing samples 48 and 68, which contain a high (1.08) molar ratio of GMA/ Acid, the presence of 20 phr PBAT generates a 79% increase in transverse tear strength.

12. Demonstration that the Presence of the PBAT or poly(butylene succinate) PBS, have an Additional Benefit Since they themselves are Biodegradable

Thin films containing 20 and 50 phr of PBAT or PBS have been exposed to commercial composting conditions (Envirofert, Tuakau, South Auckland).

Films containing 50phr of PBAT and PBS were seen to compost faster than films with 20 phr PBAT or PBS, and both levels composted faster than films of pure PLA

13. Demonstration of Improved Contact Clarity

In some applications, a film with good contact clarity is required. Table 7 provides details on various formulations which address improvements in clarity. The resultant products may have application as a film suitable for envelope windows or ring binder pockets.

The clarity is a function of the difference in refractive index between the ester polymers and the ethylene copolymers plus an effect relating directly from crosslinking. Joncryl 4368 is a highly functional epoxide containing styrene acrylate oligomer. This gives a reactive material with an epoxide component that can be utilised at reduced levels to improve the contact clarity. It is known from the literature that this material will create gels through excessive crosslinking with acid and hydroxyl functional polymers. Literature shows that Joncryl 4368 can be used as a chain extender to improve PLA melt strength as per Mix 85. It was noted however that excessive crosslinking did not occur.

Mix 84 with a high level of reactive ethylene copolymer exhibits poor contact clarity. Removing the reactive ethylene copolymer Mix 86 or maintaining the reactive ethylene copolymer Mix 87 but adding acid functionality (Surlyn) overcame the bubble stability problem . It was also found that excessive crosslinking did not occur with the acid functional copolymer.

Mix 89 demonstrates that adding a non functional ethylene copolymer, which may add other desirable properties, it does not deteriorate the contact clarity.

Mix 90 without epoxide functional ethylene copolymer and 91 with a low level of epoxide functional ethylene copolymer, demonstrates increased acid functionality, without loss of contact clarity, while improving the bubble stability.

TABLE 1
Bubble stability vs. high Surlyn 9320 content composition

| | Control | Control | Control | Control | | | | | |
|---|---|---|---|---|---|---|---|---|---|
| MIX # | A | B | C | D | 50 | 25 | 40 | 64 | 65 |
| PLA4042 | 100 | 100 | 100 | 100 | 100 | 100 | 100 | 100 | 100 |
| SURLYN 9320 | | 15 | | | 15 | 12 | 12 | 8.6 | 6 |
| MOL % ACID | | 1.725 | | | 1.725 | 1.380 | 1.380 | 0.989 | 0.690 |
| ELVALOY PTW | | | 15 | | 10 | 8 | | | |
| MOL % GMA | | | 0.549 | | 0.366 | 0.293 | | | |
| LOTADER 8900 | | | | 15 | | | 5.3 | 4.3 | 3.0 |
| MOL % GMA | | | | 0.844 | | | 0.298 | 0.242 | 0.169 |
| GMA/ACID | | | | | 0.212 | 0.212 | 0.215 | 0.245 | 0.245 |
| MOL RATIO | | | | | | | | | |
| ECOPOL/ | | 13 | 13 | 13 | 20 | 17 | 14.7 | 11.4 | 8.2 |
| PLA RATIO | | | | | | | | | |
| FINAL 15 min | 7.7 | 12.1 | 14.9 | 21.9 | 17.8 | 16.8 | 18.6 | 17.5 | 16.9 |
| TORQUE (Nm) | | | | | | | | | |
| BUBBLE | POOR | POOR | POOR | POOR | VERY | VERY | VERY | GOOD | GOOD |
| STABILITY | | | | | GOOD | GOOD | GOOD | | |

NOTE:
Alloy compositions are in ‘parts per hundred’ (phr) of PLA.
All mixes contain 0.1 phr of Irganox 1076 antioxidant.

TABLE 2
Bubble stability vs. high GMA content composition

| | Control | Control | Control | Control | | | | | |
|---|---|---|---|---|---|---|---|---|---|
| MIX # | A | B | C | D | 45 | 20 | 48 | 66 | 67 |
| PLA4042 | 100 | 100 | 100 | 100 | 100 | 100 | 100 | 100 | 100 |
| SURLYN 9320 | | 15 | | | 6 | 6 | 6 | 4 | 2.8 |
| MOL % ACID | | 1.725 | | | 0.690 | 0.690 | 0.690 | 0.460 | 0.322 |
| ELVALOY PTW | | | 15 | | | 20 | | | |
| MOL % GMA | | | 0.549 | | | 0.732 | | | |
| LOTADER 8900 | | | | 15 | 20 | | 13.3 | 8.9 | 6.2 |
| MOL % GMA | | | | 0.844 | 1.126 | | 0.749 | 0.501 | 0.349 |
| GMA/ACID | | | | | 1.63 | 1.06 | 1.08 | 1.09 | 1.08 |
| MOL RATIO | | | | | | | | | |
| ECOPOL/ | | 13 | 13 | 13 | 20.6 | 20.6 | 16.1 | 11.4 | 9.1 |
| PLA RATIO | | | | | | | | | |
| FINAL 15 min | 7.7 | 12.1 | 14.9 | 21.9 | 20.6 | 18.3 | 19.1 | 17.2 | 16.8 |
| TORQUE (Nm) | | | | | | | | | |
| BUBBLE | POOR | POOR | POOR | GOOD | VERY | VERY | VERY | GOOD | GOOD |
| STABILITY | | | | | GOOD | GOOD | GOOD | | |

NOTE:
Alloy compositions are in ‘parts per hundred’ (phr) of PLA.
All mixes contain 0.1 phr of Irganox 1076 antioxidant.

TABLE 3
Bubble stability vs. high acid content composition - influence of PBAT

| MIX # | Control 62 | 3 | 27 | 41 | 55 | 58 | 61 |
|---|---|---|---|---|---|---|---|
| PLA4042 | 100 | 100 | 100 | 100 | 100 | 100 | 100 |
| PBAT | 20 | 20 | 20 | 20 | 20 | 20 | 20 |
| SURLYN 9320 | | 15 | 12 | 12 | 10 | 8.6 | 6 |
| MOL % ACID | | 1.725 | 1.380 | 1.380 | 1.150 | 0.989 | 0.690 |
| ELVALOY PTW | | 10 | 8 | | | | |
| MOL % GMA | | 0.366 | 0.293 | | | | |
| LOTADER 8900 | | | | 5.3 | 5.0 | 4.3 | 3 |
| MOL % GMA | | | | 0.298 | 0.281 | 0.242 | 0.169 |
| GMA/ACID MOL RATIO | | 0.212 | 0.212 | 0.215 | 0.244 | 0.244 | 0.244 |
| ECOPOL/PLA + PBAT RATIO | | 17.2 | 14.3 | 12.6 | 11.1 | 9.7 | 6.8 |
| FINAL 15 min TORQUE (Nm) | 13.4 | 18.0 | 17.9 | 17.3 | 17.0 | 16.6 | 16.5 |
| BUBBLE | POOR | VERY | VERY | VERY | VERY | GOOD | GOOD |
| STABILITY | | GOOD | GOOD | GOOD | GOOD | | |

NOTE:
Alloy compositions are in ‘parts per hundred’ (phr) of PLA.
All mixes contain 0.1 phr of Irganox 1076 antioxidant.

TABLE 4
Bubble stability vs. high GMA content composition - influence of PBAT

| | Control | Control | Control | | | | | |
|---|---|---|---|---|---|---|---|---|
| MIX # | 62 | E | F | 28 | 46 | 54 | 59 | 63 |
| PLA4042 | 100 | | | 100 | 100 | 100 | 100 | 100 |
| PBAT | 20 | 100 | 100 | 20 | 20 | 20 | 20 | 20 |
| SURLYN 9320 | | | | 6 | 6 | 4.8 | 4 | 2.8 |
| MOL % ACID | | | | 0.690 | 0.690 | 0.552 | 0.460 | 0.322 |
| ELVALOY PTW | | | 20 | 20 | | | | |
| MOL % GMA | | | 0.732 | 0.732 | | | | |
| LOTADER 8900 | | | | | 20 | 10.6 | 8.9 | 6.2 |
| MOL % GMA | | | | | 1.126 | 0.597 | 0.501 | 0.349 |
| GMA/ACID MOL RATIO | | | | 1.06 | 1.63 | 1.08 | 1.09 | 1.08 |
| ECOPOL/PLA + PBAT | | | | 17.8 | 17.8 | 11.3 | 9.7 | 7.1 |
| RATIO | | | | | | | | |
| FINAL 15 min TORQUE | 13.4 | 3.6 | 5.3 | 19.7 | 20.5 | 17.4 | 17.2 | 15.8 |
| (Nm) | | | | | | | | |
| BUBBLE | POOR | GOOD | POOR | VERY | VERY | VERY | GOOD | POOR |
| STABILITY | | | | GOOD | GOOD | GOOD | | |

NOTE:
Alloy compositions are in ‘parts per hundred’ (phr) of PLA.
All mixes contain 0.1 phr of Irganox 1076 antioxidant.

TABLE 5
Blown film properties

| | Control | | | | | | Control |
|---|---|---|---|---|---|---|---|
| MIX # | PLA | 3 | 41 | 40 | 68 | 48 | LLDPE |
| PBAT | | 20 | 20 | 0 | 20 | 0 | |
| MOL % ACID | | 1.725 | 1.380 | 1.380 | 0.690 | 0.690 | |
| MOL % GMA | | 0.366 | 0.298 | 0.298 | 0.749 | 0.749 | |
| GMA/ACID | | 0.212 | 0.215 | 0.215 | 1.08 | 1.08 | |
| MOL RATIO | | | | | | | |
| ECOPOL/(PLA + PBAT) | | 17.2 | 12.6 | 14.7 | 13.8 | 16.1 | |
| RATIO | | | | | | | |
| BUBBLE STABILITY | POOR | VERY | VERY | VERY | VERY | VERY | VERY |
| | | GOOD | GOOD | GOOD | GOOD | GOOD | GOOD |
| PUNCTURE mN/micron | 1027 | 805 | 1051 | 564 | 1182 | 1448 | 710 |
| TEAR (M/T*) mN/micron | 7.7/8.4 | 8.7/10.5 | 10/10.2 | 7.0/6.5 | 10.2/14 | 10.6/7.8 | 77/154 |
| TENSILE YIELD (M/T*) | 37.9/44.6 | 32.2/29.9 | 38.9/32.8 | 22.6/15.0 | 38/33.6 | 41/39 | 15/18 |
| MPa | | | | | | | |

NOTE:
*M/T = Properties in machine direction (M)/transverse direction (T).
All compositions are in “parts per hundred” (phr) of PLA.
All mixes contain 0.1 phr of Irganox 1076 antioxidant.

TABLE 6
Blown film compositions

| | MIX # | | | |
|---|---|---|---|---|
| | 41 | 40 | 68 | 48 |
| PLA | 100 | 100 | 100 | 100 |
| PBAT | 20 | 0 | 20 | 0 |
| MOL % ACID | 1.380 | 1.380 | 0.690 | 0.690 |
| MOL % GMA | 0.298 | 0.298 | 0.749 | 0.749 |
| GMA/ACID MOL RATIO | 0.215 | 0.215 | 1.08 | 1.08 |
| BUBBLE STABILITY | VERY | VERY | VERY | VERY |
| | GOOD | GOOD | GOOD | GOOD |
| SURLYN 9320 | 12 | 12 | 6 | 6 |
| LOTADER 8900 | 5.3 | 5.3 | 13.3 | 13.3 |
| ECOPOL/ | 12.6 | 14.7 | 13.8 | 16.1 |
| (PBAT + PLA) % | | | | |

NOTE:
All compositions are in “parts per hundred”(phr) of PLA. All mixes contain 0.1phr of Irganox 1076 antioxidant.

TABLE 7
Film compositions with contact clarity

| MIX # | 84 | 85 | 86 | 87 | 89 | 90 | 91 |
|---|---|---|---|---|---|---|---|
| PLA | 100 | 100 | 100 | 100 | 100 | 100 | 100 |
| PBS | 20 | 50 | 51 | 50 | 51 | 51 | 50 |
| SURLYN 9320 | 12 | 0 | 1.0 | 1.0 | 1.0 | 3.0 | 3.0 |
| LOTADER AX8900 | 5.3 | 1.2 | 0 | 1.2 | 0 | 0 | 1.2 |
| JONCRYL 4368 | — | 0.3 | 0.3 | 0.3 | 0.3 | 0.3 | 0.3 |
| ELVALOY 1335 | — | 0 | 0 | 0 | 10 | 0 | 0 |
| MOL % ACID | | 0 | 0.116 | 0.116 | 0.116 | 0.348 | 0.348 |
| CONTACT | POOR | GOOD | GOOD | GOOD | GOOD | GOOD | GOOD |
| CLARITY | | | | | | | |
| BUBBLE | Good | Poor | Good | Good | Good | Very | Very |
| STABILITY | | | | | | Good | Good |
| ECOPOL/ | 12.6 | 0.99 | 0.85 | 1.64 | 6.9 | 2.1 | 2.9 |
| (PBAT, PBS + PLA) | | | | | | | |
| % | | | | | | | |

NOTE:
All compositions are in “parts per hundred” (phr) of PLA.
All mixes contain 0.1 phr of Irganox 1076 antioxidant.

14. Demonstration of Improvements in Extrusion Blow Moulding

TABLE 8
Extrusion Blow Moulded Bottle Composition

| | Mix # |
|---|---|
| | 160 |
| PLA 4042 | 100 |
| Surlyn 9320 | 13 |
| Irganox 1076 | 0.1 |
| Enpol 8060 (PBAT) | 50 |
| Lotader AX 8900 | 6 |

The material (mix 160) was pre-compounded on a Lab Tech twin screw extruder and dried. This material was converted into 250 ml bottles using a Hesta 36 mm blow extrusion line configured for polyethylene. The temperature profile was 175° C. through to 240° C. on the die. Samples of these bottles were stored in an oven at 80° C. overnight with no visible distortion. An injection stretch blow moulded 650 ml water bottle manufactured from PLA and used as a control, which distorted after 10 minutes of heating.

15. Demonstration of Improvements in Profile Extrusion

TABLE 9
Profile Extrusion Compositions

Mix #

| | 164 | 165 |
|---|---|---|
| PLA 4042 | 100 | 100 |
| Surlyn 9020 | 6 | 12 |
| Irganox 1076 | 0.2 | 0.1 |
| Enpol 8060 (PBAT) | 50 | 30 |
| Elvaloy 4170 | — | 5 |
| 20% Joncryl 4368 in PBS | 2.2 | — |
| 10% Erucamide in PBAT | 1.5 | — |

Formulation 164 and 165 were compounded on a Lab Tech twin screw extruder and dried overnight. A profile with a U section approximately 42 mm wide and 26 mm deep was extruded using a 2.5 inch Prodex extruder fitted with a barrier screw. The temperature profile was 180 to 186° C. A PLA resin 4042D from Natureworks was trialled and had insufficient hot strength to hold the profile shape and flowed away to the floor. Formulation No. 164 had sufficient hot strength to form a profile but necked down during processing resulting in an under size profile. Formulation No. 165 demonstrated very good melt strength holding both the profile size and shape.

Although the invention has been described with reference to specific examples, it will be appreciated by those skilled in the art that the invention may be embodied in many other forms. In particular features of any one of the various described examples may be provided in any combination in any of the other described examples.

1-42. (canceled)

43. A reactive mixture, comprising a poly(hydroxyalkanoic acid) or a copolymer thereof and a reactive composition comprising a total of about 0.1 to 15 wt % of a glycidyl functionality, and a total of about 0.1 to 15 wt % of an organic carboxylic acid functionality.

44. A reactive mixture according to claim 43 wherein said reactive composition is polymeric.

45. A reactive mixture according to claim 43 wherein said poly(hydroxyalkanoic acid) comprises repeat units derived from hydroxyalkanoic acid having five or fewer carbon atoms.

46. A reactive mixture according to claim 45 wherein the repeat units are selected from the group consisting of: glycolic acid, lactic acid, 3-hydroxypropionic acid, 2-hydroxybutyric acid, 3-hydroxybutyric acid, 4-hydroxybutyric acid, 3-hydroxyvaleric acid, 4-hydroxyvaleric acid, 5-hydroxyvaleric acid, or combinations of two or more thereof

47. A reactive mixture according to claim 46 wherein the poly(hydroxyalkanoic acid) comprises poly(glycolic acid), poly(lactic acid), polyhydroxy-butanoic acid, polyhydroxybutyrate-hydroxyvalerate copolymer, copolymer of glycolic acid and lactic acid, or combinations of two or more thereof

48. A reactive mixture according to claim 46 wherein the poly(hydroxyalkanoic acid) is poly(lactic acid).

49. A reactive mixture according to claim 43 wherein said first reactable component is a first polymer comprising said glycidyl moieties and said second reactable component is a second polymer comprising said carboxylic acid moieties.

50. A reactive mixture according to claim 49 wherein said first polymer additionally comprises isocyanate, axiridine, silane, alkyl halide, alpha-halo ketone, alpha-halo aldehyde, and/or oxazoline moieties or mixtures thereof

51. A reactive mixture according to claim 49 wherein said first polymer and said second polymer are based on ethylene, and optionally comprises grafted homo polymers or copolymers.

52. A reactive mixture according to claim 51 wherein said ethylene (co)polymer bearing epoxide groups is made by polymerizing monomers (a) ethylene and (b) one or more olefins of the formula CH₂═C(R¹)CO₂R², where R¹ is hydrogen or an alkyl group with 1 to 8 carbon atoms such as methyl, ethyl, or butyl, and R² is a glycidyl/epoxy moiety.

53. A reactive mixture according to claim 49 wherein said ethylene copolymer bearing organic carboxylic acid groups is made by polymerizing monomers (a) ethylene and (b) one or more olefins of the formula CH₂═C(R¹)COOH, where R¹ is hydrogen or an alkyl group with 1 to 8 carbon atoms such as methyl, ethyl, or butyl.

54. A reactive mixture according to claim 52 wherein repeat units derived from monomer (a) comprise about 20 to about 95 weight % and repeat units derived from monomer (b) comprise about 3 to about 70 weight %.

55. A reactive mixture according to claim 52 wherein said epoxide moieties are derived from glycidyl acrylate or methacrylate, and said carboxylic acid moieties are derived from acrylic or methacrylic acid.

56. A reactive mixture according to claim 43 wherein said mixture comprises between about 60 to about 95 weight percent of said poly(hydroxyalkanoic acid) and the remainder being said reactive composition.

57. A reactive mixture according to claim 43 wherein said mixture of ethylene copolymers comprises about 5 to 8 weight percent of glycidyl functionality and about 10 weight percent of organic carboxylic acid functionality.

58. A reactive mixture according to claim 57 wherein said ethylene copolymers also contain up to 30 weight percent of an additional acrylate or methacrylate monomer having a glass transition temperature from about -25 to -60° C.

59. A reactive mixture according to claim 43 further comprising an additional component for improving the tear strength of film blown from said reactive mixture.

60. A reactive mixture according to claim 59 wherein said additional component is a polymer which is relatively more elastic than said reacted mixture.

61. A reactive mixture according to claim 60 wherein said additional component is PBAT, PBS.

62. A reactive mixture according to claim 43 further comprising other additives comprising about 0.5 to about 50 weight % plasticizer; about 0.1% to about 1.5% chain extender; about 0.1 to about 5 weight % antioxidants and stabilizers; about 3 to about 40 weight % fillers; about 5 to about 40 weight % reinforcing agents; about 0.5 to about 10 weight % nanocomposite reinforcing agents; and/or about 1 to about 40 weight % flame retardants.

63. A reactive mixture according to claim 43 wherein film produced from said mixture comprises a melt strength greater than pure poly(lactic acid).
